(19) United States
(12) Patent Application Publication
(10) Pub. No.: US 2015/0127203 A1
(43) Pub. Date: May 7, 2015

(54) VEHICLE TRAVEL CONTROL ASSISTANCE DEVICE

(71) Applicant: Yusuke Kashiba, Toyota-shi (JP)

(72) Inventor: Yusuke Kashiba, Toyota-shi (JP)

(73) Assignee: TOYOTA JIDOSHA KABUSHIKI KAISHA, Toyota-shi, Aichi (JP)

(21) Appl. No.: 14/397,932

(22) PCT Filed: May 15, 2012
(86) PCT No.: PCT/JP12/62402

§ 371 Date: Oct. 30, 2014

(51) Int. Cl. B60W 10/24; G01C 21/34; B60W 20/00

(52) U.S. Cl. CPC B60W 10/24; B60W 20/00; G01C 21/34
USPC 701/22

(57) ABSTRACT

An electronic control unit installed on a vehicle acquires, via a smart center provided outside, a power failure occurrence notification for notifying a state in which a power failure has occurred in a house that is an own house or a power failure recovery notification for notifying a state in which the house has recovered from a power failure. When the electronic control unit receives the power failure occurrence notification from the center, the electronic control unit changes a travel mode of the vehicle from a travel mode of traveling only by a driving force of a motor/generator to a travel mode of traveling by driving forces of the motor/generator and an internal combustion engine, thereby suppressing electric power consumed by the travel. As a result, even if the vehicle moves to the house by travel, electric power to be supplied to the house via an electric power supply part can be surely secured.

### TECHNICAL FIELD

The present invention relates to a vehicle travel control assistance device for assisting a change in travel control for a vehicle, and more particularly, to a vehicle travel control assistance device for assisting a change in travel control for a vehicle which can supply electric power stored in an electricity storage device to the outside.

### BACKGROUND ART

Hitherto, for example, an emergency electric power distribution system disclosed in Patent Literature 1 has been known. The related-art emergency electric power distribution system includes a facility such as a hospital that requires emergency electric power, an emergency center including an emergency electric power distribution device for creating an emergency electric power distribution plan, a group of hybrid vehicles each having a power generation function and a high-capacity electricity storage device, and a network for connecting those components to one another for communication. Then, the emergency electric power distribution device includes an insufficient electric power amount acquisition module for acquiring an insufficient electric power amount from the facility such as a hospital, a vehicle information acquisition module for acquiring vehicle information such as a current location from the hybrid vehicle group, a vehicle determination module for determining a vehicle to which an emergency electric power distribution is requested, and a guidance information transmission module for transmitting information for guidance to the facility such as a hospital to the vehicle determined to be requested for the emergency electric power distribution. As a result, the related-art emergency electric power distribution system can efficiently concentrate the electric vehicles, which can supply the electric power to the outside, to the facility such as a hospital when electric power shortage occurs.

Moreover, hitherto, for example, an electric power supply system disclosed in Patent Literature 2 has also been known. In this related-art electric power supply system, a vehicle is configured to be connected to a wall socket of a residential house to generate AC commercial electric power to be supplied to a power transmission line. Moreover, in this related-art electric power supply system, the vehicle is configured to be able to communicate to/from a management server via the residential house and the power transmission line, so as to output information on the vehicle such as a vehicle ID, a generated electric power amount, and a remaining amount of fuel to the management server. As a result, the management server is configured to be able to generate and output an activation command and an electric power generation command to the vehicle based on the information on the vehicle when electric power shortage occurs.

Moreover, hitherto, for example, an electric power transmission/distribution system, an emergency electric device, and a method of operating an electric power transmission/distribution system disclosed in Patent Literature 3 have also been known. This related-art electric power transmission/distribution system is configured to supply power distribution lines in an entire area or power distribution lines in a specific area with electric power at an emergency supply voltage lower than a normal supply voltage by 15% to 55% when supplied electric power is insufficient. In this case, a power generator installed on a hybrid vehicle or a fuel cell vehicle is used as an emergency power source to supply the power distribution lines with the electric power through an electric power transmission connection port from the power generator via a power conditioner.

Further, hitherto, for example, a vehicle control device disclosed in Patent Literature 4 has also been known. In this related-art vehicle control device, an ECU controls SOCs of a master battery and a sub battery so that the SOCs change within a range between predetermined upper and lower limits. In this case, if such a condition that charge is expected to be carried out by using electric power supplied from the outside of a plug-in hybrid vehicle is satisfied, control is carried out so that the SOC of the sub battery is lower than the SOC of the master battery.

### CITATION LIST

### Patent Literature

[PTL 1] JP 2009-33808 A

[PTL 2] JP 2006-345621 A

[PTL 3] JP 2005-168258 A

[PTL 4] JP 2010-58640 A

### SUMMARY OF INVENTION

By the way, the related-art systems and the like disclosed in Patent Literatures 1 to 3 are configured so that the electric power can be supplied from the vehicle to the outside. However, for example, if a current location of the vehicle and a specified location (destination), which is an electric power supply destination to be supplied with electric power, are remote from each other, the vehicle needs to travel to the electric power supply destination (destination). In this case, if electric power stored in a battery (electricity storage device) of the vehicle is excessively consumed by the travel, when the vehicle arrives at the electric power supply destination (destination), electric power required by the supply destination may not be efficiently and quickly secured.

The present invention has been made in view of the above-mentioned problem, and therefore has an object to provide a vehicle travel control assistance device capable of appropriately changing a usage form of electric power consumed by travel depending on an electric power state of an electric power supply destination.

A vehicle travel control assistance device according to one embodiment of the present invention for achieving the above-mentioned object is applicable to a vehicle that includes: a motor/generator for generating a driving force and generating regenerative electric power; and an electricity storage device, which is electrically connected to the motor/generator, for supplying electric power to the motor/generator and storing the regenerative electric power therein, and supplying the stored regenerative electric power to an outside, the vehicle being capable of providing a plurality of pieces of travel control using at least the driving force generated by the motor/generator. Then, the vehicle travel control assistance device includes control means for assisting a change in the plurality of pieces of travel control.

One feature of the present invention resides in that the control means is configured to: acquire an electric power state relating to supply and demand of electric power at an external electric power supply destination to which the electric power stored in the electricity storage device is to be supplied; and change a usage form of electric power in which at least the motor/generator consumes the electric power stored in the electricity storage device as the vehicle travels depending on the acquired electric power state, or inform to prompt to change the usage form of electric power. Note that, in this case, the control means may include: electric power state acquisition means for acquiring an electric power state relating to supply and demand of electric power at an external electric power supply destination to which the electric power stored in the electricity storage device is to be supplied; and usage form changing means for changing, depending on the electric power state acquired by the electric power state acquisition means, a usage form of electric power in which at least the motor/generator consumes the electric power stored in the electricity storage device as the vehicle travels. Further, in this case, the control means may include storage means for storing the electric power state acquired by the electric power state acquisition means, and the usage form changing means may include informing means for informing to prompt to change the usage form of electric power.

On this occasion, the external electric power supply destination is an own house of a user of the vehicle, and the control means, for example, may acquire the electric power state by means of communication from an external center provided so as to be able to communicate to/from the own house, or from the own house by means of direct communication. Further, in this case, the external center, for example, may be provided so as to be able to communicate to/from a plurality of houses in an area including the own house, and may transmit the electric power states transmitted from the plurality of houses to the control means installed on vehicles relating to the respective plurality of houses.

In those cases, the control means may be configured to acquire, as the electric power state, at least an occurrence state of a power failure in which commercial electric power is not supplied to the external electric power supply destination, or a state in which a consumed amount of electric power is tight with respect to a supplied amount of electric power at the external electric power supply destination. Further, in this case, the control means may be configured to acquire the occurrence state of the power failure or the state in which the consumed amount of electric power is tight with respect to the supplied amount of electric power as a state of an area in which the external electric power supply destination exists. Moreover, in this case, the control means may be configured to acquire a state in which the consumed amount of electric power is tight with respect to the supplied amount of electric power in future, which is estimated by using the consumed amount of electric power with respect to the supplied amount of electric power at a current time point, as the state in which the consumed amount of electric power is tight with respect to the supplied amount of electric power. Then, in this case, more specifically, the estimated state in the future in which the consumed amount of electric power is tight with respect to the supplied amount of electric power may be a state in which the consumed amount of electric power is tight with respect to the supplied amount of electric power at a time point when the vehicle arrives at the external electric power supply destination.

Further, in those cases, the control means may be configured to change, depending on the acquired electric power state, the usage form of electric power from a first usage form of electric power in which an electric power consumed amount of the electric power stored in the electricity storage device, which is consumed as the vehicle travels, increases to a second usage form of electric power in which the electric power consumed amount of the electric power stored in the electricity storage device, which is consumed as the vehicle travels, decreases as compared with the first usage form of electric power, or inform to prompt to change the usage form of electric power from the first usage form of electric power to the second usage form of electric power.

In this case, more specifically, when the control means acquires, as the acquired electric power state, at least an occurrence state of a power failure in which commercial electric power is not supplied to the external electric power supply destination, or a state in which a consumed amount of electric power is tight with respect to a supplied amount of electric power at the external electric power supply destination, the control means may be configured to change the usage form of electric power from the first usage form of electric power to the second usage form of electric power or inform to prompt to change the usage form of electric power from the first usage form of electric power to the second usage form of electric power.

Then, in those cases, for example, when the vehicle includes an internal combustion engine installed thereon in addition to the motor/generator, and is capable of carrying out travel control in a travel mode of using only the driving force of the motor/generator and a travel mode of using both the driving force of the motor/generator and a driving force of the internal combustion engine, the control means may be configured to change, depending on the acquired electric power state, the travel control from travel control in the travel mode of using only the driving force of the motor/generator to travel control in the travel mode of using both the driving force of the motor/generator and the driving force of the internal combustion engine, or inform to prompt to change the travel control from the travel control in the travel mode of using only the driving force of the motor/generator to the travel control in the travel mode of using both the driving force of the motor/generator and the driving force of the internal combustion engine, thereby changing the usage form of electric power from the first usage form of electric power to the second usage form of electric power.

Further, in those cases, the vehicle travel control assistance device may further include route search means for searching for a route to a predetermined destination, and the control means may be configured to, when the vehicle is under the travel control in the travel mode of using the driving force of the motor/generator: control the route search means to search for at least one of a route of suppressing the consumption of the electric power by the motor/generator or a route of increasing a collected electric power amount of the regenerative electric power by the motor/generator among routes from a current location of the vehicle to the external electric power supply destination; and present and guide the route retrieved by the route search means depending on the acquired electric power state, and change the first usage form of electric power to the second usage form of electric power.

With those configurations, the control means installed on the vehicle may acquire the electric power state of the external electric power supply destination by means of communication, for example, via the own house, which is an external electric power supply destination, or a center externally provided. As a result, the control means can recognize a supply/demand state of the electric power at the external electric power supply destination (such as the own house of the user). Then, the control means may change the usage form of the electric power stored in the electricity storage device from the first usage form to the second usage form, or may prompt the change depending on the acquired electric power state, more specifically, in a state in which a power failure has occurred at the external electric power supply destination or a state in which a consumed amount of electric power is tight with respect to a supplied amount of electric power.

On this occasion, if the vehicle is a vehicle (such as a hybrid vehicle or a plug-in hybrid vehicle) including a motor/generator and an internal combustion engine, the control means may change the travel control for the vehicle from travel control in a travel mode (EV mode) of using only a driving force of the motor/generator to travel control in a travel mode (HV mode) of using the driving forces of the motor/generator and the internal combustion engine. Moreover, if the vehicle is a vehicle (pure electric vehicle) on which only the motor/generator is installed, the control means may present and guide a route of suppressing the consumption of the electric power by the motor/generator or a route of increasing a collected electric power amount of regenerative electric power by the motor/generator, and may increase a frequency of regenerative control for the motor/generator to increase the collected electric power amount of the regenerative electric power, or limit a magnitude of the driving force generated by the motor/generator. As a result, for example, in a state in which a power failure has occurred at the own house, which is the external electric power supply destination, or in a state in which a consumed amount of electric power is tight, an electric power amount consumed by the travel out of the electric power stored in the electricity storage device can be suppressed, and an electric power amount supplied to the electric power supply destination can be sufficiently and quickly secured.

### BRIEF DESCRIPTION OF DRAWINGS

FIG. 1 is a schematic diagram of an electric power system to which a vehicle travel control assistance device according to an embodiment of the present invention can be applied.

FIG. 2 is a block diagram schematically illustrating a configuration of an in-vehicle terminal device installed on the vehicle of FIG. 1.

FIG. 3 is a block diagram schematically illustrating a configuration of an electric power supply part installed on the vehicle of FIG. 1.

FIG. 4 is a block diagram schematically illustrating a configuration of a terminal device installed in a house of FIG. 1.

FIG. 5 is a block diagram schematically illustrating a configuration of a smart center 40 of FIG. 1.

FIG. 6 is a flowchart of a travel control assistance program, a power failure occurrence detection program, and a notification transmission program to be executed by the vehicle, the house, and the smart center of FIG. 1 in cooperation.

FIG. 7 is a flowchart of the travel control assistance program and the notification transmission program to be executed by the vehicle and the smart center of FIG. 1 in cooperation according to a first modified example of the present invention.

FIG. 8 is a flowchart of the travel control assistance program and the power failure occurrence detection program to be executed by the vehicle and the house of FIG. 1 in cooperation according to a second modified example of the present invention.

### DESCRIPTION OF EMBODIMENTS

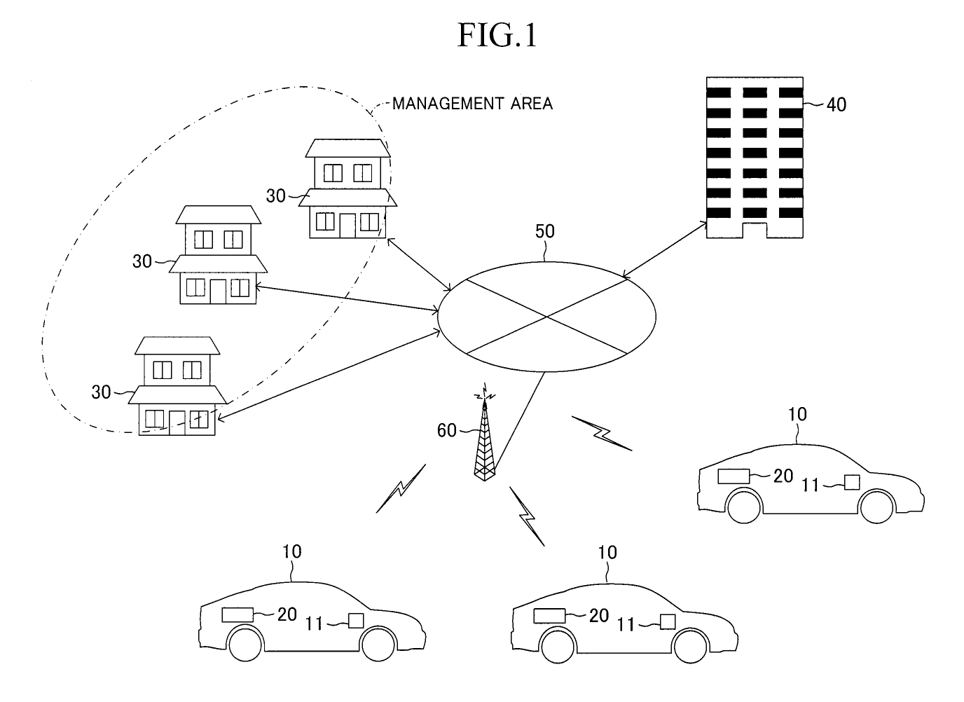

A description is now given of a vehicle travel control assistance device according to an embodiment of the present invention referring to the drawings. FIG. 1 illustrates a schematic configuration of an electric power system to which the vehicle travel control assistance device according to this embodiment can be applied. This electric power system is constructed by vehicles 10 on each of which the vehicle travel control assistance device is installed, houses 30 (such as own houses of users of the vehicles 10) as external power supply destinations each of which can receive electric power (specifically, emergency electric power) from an electric power supply part 20 provided for the vehicle 10, and a smart center 40 for monitoring a supply state of commercial electric power to the houses 30 existing in a management area. Then, the plurality of vehicles 10, the plurality of houses 30, and the smart center 40 for monitoring the supply states of the commercial electric power to the houses 30 are connected to each other for mutual communication via a network 50 such as the Internet line network and a cellular phone line network and a relay station 60 in the electric power system according to this embodiment.

The vehicle 10 is an electric vehicle (EV) including a motor/generator (electric motor for driving and power generation), a hybrid vehicle (HV) including an internal combustion engine in addition to a motor/generator, a plug-in hybrid vehicle (PHV) which is a hybrid vehicle (HV) and is chargeable by using an external electric power supply, and the like. Then, as described later, the vehicle 10 includes the power supply part 20 connected to an electric power line wired to the house 30 for supplying (providing) electric power (emergency electric power).

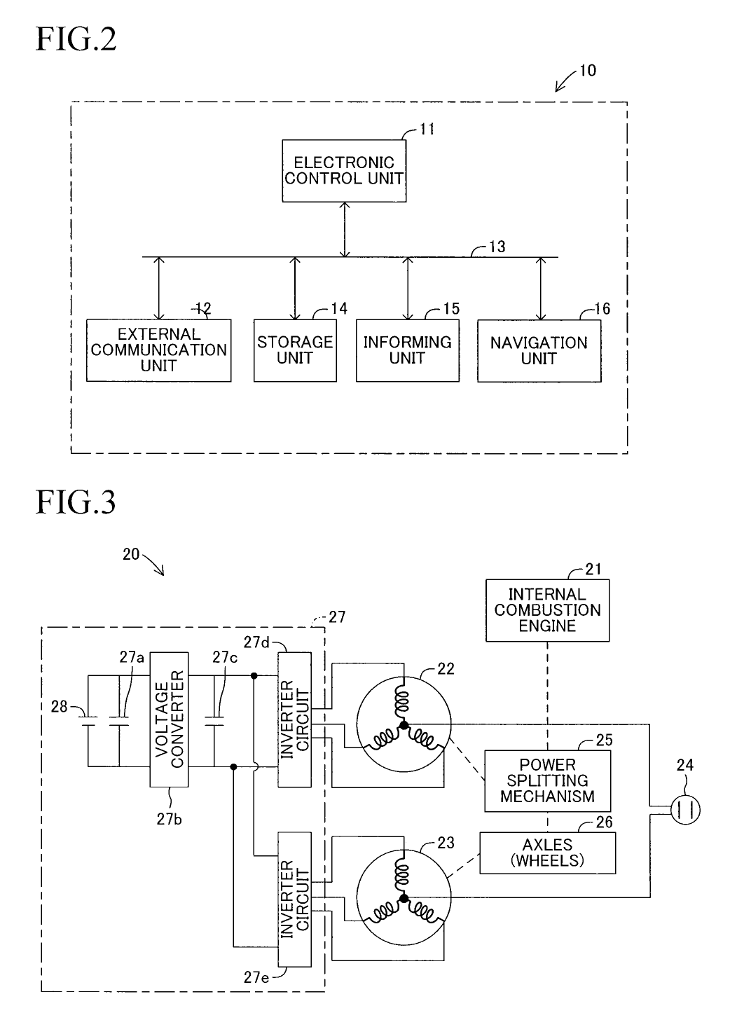

As illustrated in FIG. 2, the vehicle 10 includes an electronic control unit 11 as control means constructing the vehicle travel control assistance device. The electronic control unit 11 is a microcomputer including a CPU, a ROM, a RAM, and the like as main components, and executes various programs including a travel control assistance program to be described later, thereby automatically switching a travel driving state of the vehicle 10 or prompting a user (driver) to switch the travel driving state, and thereby changing or prompting to change a usage form of electric power consumed by the travel as specifically described later.

Therefore, the vehicle 10 includes an external communication unit 12 as acquisition means constructing the vehicle travel control assistance device. The external communication unit 12 is, for example, a data communication module (DCM) or the like connected to the electronic control unit 11 for communication to/from the electronic control unit 11 via a controller area network (CAN) communication line 13 built in the vehicle 10. Further, the external communication unit 12 connects to the network 50 through wireless communication via the relay station 60 to communicate to/from the smart center 40 (or the house 30) connected to the network 50.

Moreover, the vehicle 10 includes a storage unit 14 as storage means constructing the vehicle travel control assistance device. The storage unit 14 includes a storage medium such as a hard disk and a semiconductor memory, and a drive device for the storage medium, and stores the various programs executed by the electronic control unit 11 and various data. Therefore, the storage unit 14 is connected to the electronic control unit 11 via the CAN communication line 13. Moreover, the vehicle 10 includes an informing unit 15 as informing means constructing the vehicle travel control assistance device. The informing unit 15 is constructed by a display, a speaker, and the like, and displays characters, graphics, and the like on a screen of the display and outputs a sound from the speaker by following control by the electronic control unit 11. Therefore, the informing unit 15 is connected to the electronic control unit 11 via the CAN communication line 13.

Further, the vehicle 10 includes a navigation unit 16 as route search means constructing the vehicle travel control assistance device. The navigation unit 16 is connected to the CAN communication line 13, and uses, for example, various data stored in a predetermine storage location of the storage unit 14 or various data acquired from an external center (not shown) connected via the external communication unit 12 to the network 50 to search for a route to a destination (specifically, in this embodiment, the house 30 such as the own house of the user). Then, the navigation unit 16 carries out display on the display of the informing unit 15, or outputs a sound, thereby guiding the retrieved route. On this occasion, the navigation unit 16 includes at least a global positioning system (GPS) signal detection sensor as a sensor required to detect a current location of the vehicle 10.

If the vehicle 10 is, for example, an HV or a PHV, as illustrated in FIG. 3, the vehicle 10 includes the electric power supply unit 20. On this occasion, the electric power supply unit 20 according to this embodiment uses, for example, a neutral point of a motor/generator of the vehicle 10, thereby enabling an electric power transmission/reception between the vehicle 10 and the house 30. A configuration of the electric power supply part 20 itself and the electric power transmission/reception operation to/from the house 30 do not directly relate to the present invention, and hence a brief description is given thereof.

As illustrated in FIG. 3, the electric power supply part 20 in an HV or a PHV includes an internal combustion engine 21, motors/generators 22 and 23, and an electric power supply socket-outlet 24. A power output by the internal combustion engine 21 drives axles (wheels) 26 via a power splitting mechanism 25. If the vehicle 10 is an EV, the internal combustion engine 21 and the power splitting mechanism 25 are omitted in the electric power supply part 20.

The motors/generators 22 and 23 are so-called motor/generator, and are three-phase synchronous motors/generators, each of which functions as a motor when an electric power is supplied, and functions as a generator by power from the outside. The motor/generator 22 controls a rotational speed of the internal combustion engine 21 via the power splitting mechanism 25 so that the internal combustion engine 21 operates at an efficient operation point, and the motor/generator 22 also functions as a generator. The motor/generator 23 outputs a torque corresponding to an insufficient amount of the torque output from the internal combustion engine 21 for a vehicle-requiring driving force to the axles (wheels) 26. In this way, the internal combustion engine 21 and the motors/generators 22 and 23 are coupled to each other via the power splitting mechanism 25. On this occasion, the power splitting mechanism 25 is a publicly-known planetary gear constructed by three elements of a sun gear, a carrier, and a ring gear, and the sun gear is connected to the motor/generator 22, the carrier is connected to the internal combustion engine 21, and the ring gear is connected to the axles (not shown) and the motor/generator 23.

Moreover, the power supply unit 20 is constructed by an electric power supply circuit 27. The electric power supply circuit 27 includes a smoothing capacitor 27a on an electricity storage device 28 side, a voltage converter 27b, a smoothing capacitor 27c on a booster side, and invertor circuits 27d and 27e. As a result, the electric power supply circuit 27 has the following functions. Specifically, when the electric power supply circuit 27 transmits (supplies) the electric power (emergency electric power) from the electric power supply socket-outlet 24 to the house 30, the electric power supply circuit 27 converts DC electric power of the high-capacity electricity storage device 28 into AC electric power, and uses the neutral point of the motors/generators 22 and 23 to transmit (supply) the AC electric power from the electric power supply socket-outlet 24 to the house 30. Moreover, if the state of charge (SOC) of the electricity storage device 28 becomes insufficient as a result of the transmission (supply) of the electric power to the house 30, the internal combustion engine 21 is used to operate the motors/generators 22 and 23 as generators to charge the electricity storage device 28. Note that, the electricity storage device 28 is a high-voltage and high-capacity rechargeable battery, and a lithium-ion battery pack, a nickel-hydrogen battery back, a capacitor, and the like can be used as the electricity storage device 28.

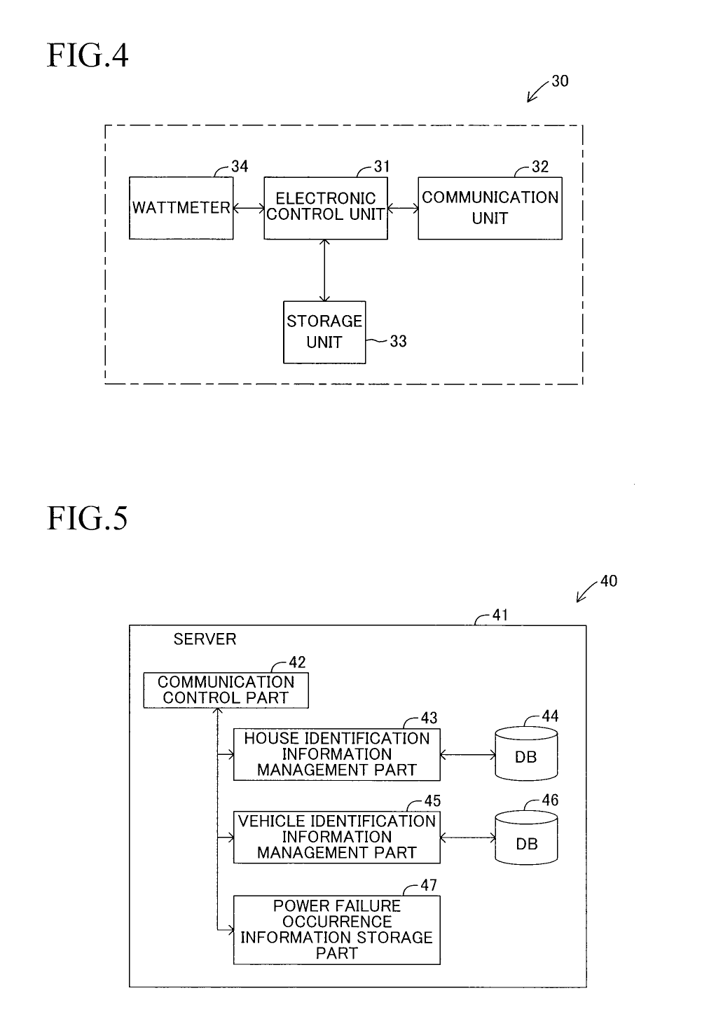

As illustrated in FIG. 4, the house 30 includes an electronic control unit 31, a communication unit 32, a storage unit 33, and a wattmeter 34, which are connected to one another for mutual communication. The electronic control unit 31 is a microcomputer including a CPU, a ROM, and a RAM as main components, and executes various programs to centrally control the electric power supply to various electric devices in the house 30 to which the commercial electric power or the emergency electric power from the vehicle 10 is supplied. The communication unit 32 is connected to the network 50, and communicates to/from the smart center 40 (or the vehicle 10 via the relay station 60). Moreover, the communication unit 32 is provided so as to communicate to/from the electronic control unit 31 via a communication line built in the house 30.

The storage unit 33 includes a storage medium such as a hard disk and a semiconductor memory, and a drive device for the storage medium, and stores the various programs executed by the electronic control unit 31 and various data. Therefore, the storage unit 33 is also provided so as to communicate to/from the electronic control unit 31 via the communication line built in the house 30. The wattmeter 34 is a so-called smart meter, for example, and is provided on a power transmission line for supplying the house 30 with the commercial electric power. The wattmeter 34 detects an electric power state from an electric power company or the like, namely whether the commercial electric power is supplied to the house 30 or a power failure has occurred, and detects an electric power amount (consumed electric power amount) consumed in the house 30. Then, the wattmeter 34 is also provided so as to communicate to/from the electronic control unit 31 via the communication line built in the house 30.

The smart center 40 is a facility for acquiring various pieces of information transmitted via the network 50 from the electronic control units 31 provided in the respective houses 30 in the management area or the electric power company, and monitoring an electric power supply state in the management area based on the various pieces of information, namely an electric power supply state and a power failure state of the commercial electric power for the houses 30 existing in the management area. Therefore, as illustrated in FIG. 5, a server 41 including a microcomputer as a main component is provided for the smart center 40.

The server 41 includes a communication control part 42 connected to the network 50 for controlling communication, a house identification information management part 43 for managing house identification information for identifying the respective houses 30 in the management area, a house identification information storage part 44 for storing a database for the house identification information, a vehicle identification information management part 45 for managing vehicle identification information for identifying the vehicles 10 used by users in association with the house identification information, and a vehicle identification information storage part 46 for storing a database for the vehicle identification information.

The house identification information storage part 44 stores, in order to identify and specify the respective houses 30, house ID information including a resident (user) name, a phone number, an address, and the like, which is assigned in advance, as the house identification information in a form enabling search. Moreover, the vehicle identification information storage part 46 stores, for example, vehicle ID information including the house ID information, and assigned in advance in a form enabling search in order to identify the vehicle 10 used by the user (resident), associates account information (such as a user name, an account name, an access password, and a mail address of the user) used by the server 41 for mutually communicating to/from the electronic control unit 11 via the external communication unit 12 of the vehicle with the vehicle ID information, and stores the associated account information as the vehicle identification information in a form enabling search. As a result, when the server 41 acquires the house identification information from the electronic control unit 31 of the house 30, the house identification information management part 43 and the vehicle identification information management part 45 cooperate with each other to acquire the vehicle identification information associated with the house identification information by means of the search, and identifies (authenticates) the vehicle 10 used by the user, namely the resident of the house 30.

Moreover, the server 41 includes a power failure occurrence information storage part 47 for accumulating and storing power failure occurrence information representing a power failure state of the commercial electric power that has occurred in the house 30 and power failure recovery information representing a recovery from a power failure state that has occurred in the house 30, which are transmitted from the house 30 in the management area, in association with the house identification information. As a result, when the server 41 acquires the power failure occurrence information or the power failure recovery information representing the electric power state along with the house identification information from the electronic control unit 31 of the house 30, the power failure occurrence information storage part 47 associates the house identification information and the power failure occurrence information or the power failure recovery information with each other, and further associates the associated information with time information with each other, which are then stored in a form enabling search.

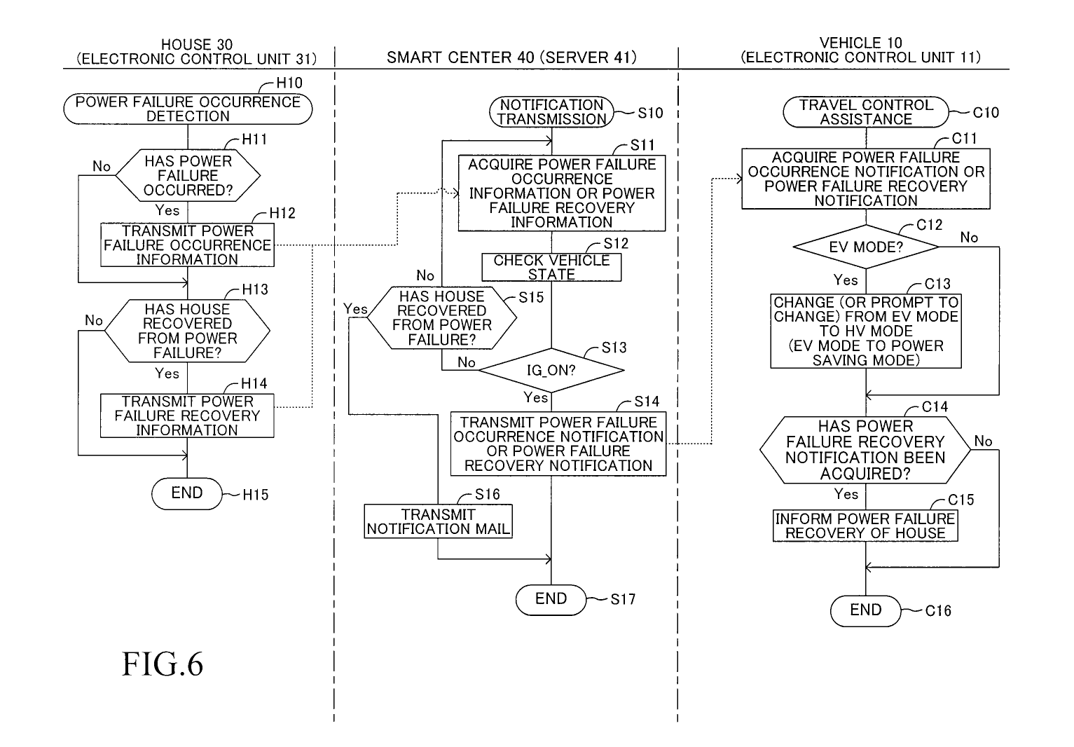

Next, a detailed description is given of an operation of the vehicle travel control assistance device applied to the electric power system configured as described above. In the electric power system, the electronic control unit 11 of the vehicle 10, the electronic control unit 31 of the house 30, and the server 41 of the smart center 40 cooperate with one another to execute the travel control assistance program, a power failure occurrence detection program, and a notification transmission program illustrated in FIG. 6 in association with one another. Referring to FIG. 6, a specific description is now given thereof.

First, a description is given of the power failure occurrence detection program to be executed by each of the electronic control units 31 of the plurality of houses 30 in the management area of the smart center 40. Each of the electronic control units 31 of the houses 30 in the management area acquires a detection result by the wattmeter 34, specifically, whether the commercial electric power is supplied to the house 30 or a power failure has occurred (hereinafter referred to as “electric power reception state”) via the communication line built in the house 30 and a consumed electric power amount, and stores the acquired detection result and consumed electric power amount respectively at predetermined storage locations in the storage units 33.

Thus, the electronic control unit 31 starts the power failure occurrence detection program illustrated in FIG. 6 in Step H10 at a predetermined frequency, and then in Step H11, determines whether or not a power failure is currently occurring in the house 30 based on the electric power reception state output from the wattmeter 34. In other words, based on the electric power reception state acquired from the wattmeter 34, when the commercial electric power is not currently supplied to the house 30, which means that a power failure is occurring in the house 30, the electronic control unit 31 makes a determination “Yes”, and proceeds to Step H12.

On the other hand, based on the electric power reception state acquired from the wattmeter 34, when the commercial electric power is currently supplied to the house 30, which means that a power failure has not occurred in the house 30, the electronic control unit 31 makes a determination “No”, and proceeds to Step H13. Note that, a backup electricity storage device (not shown) is provided in the house 30, and even if the commercial electric power is not available (in other words, if a power failure has occurred), the electronic control unit 31 can use electric power stored in the emergency electricity storage device to execute the power failure occurrence detection program only for a given period of time.

In Step H12, the electronic control unit 31 transmits the power failure occurrence information representing that a power failure is currently occurring in the house 30 along with the house identification information to the smart center 40 based on the determination result in Step H11. Specifically, the electronic control unit 31 acquires the house identification information that is stored in advance at a predetermined storage location in the storage unit 33 and distributed by the smart center 40, and supplies the communication unit 32 with the house identification information and the power failure occurrence information along with a transmission request. The communication unit 32 transmits the house identification information and the power failure occurrence information via the network 50 to the smart center 40 by following the supplied transmission request. Then, when the communication unit 32 transmits the house identification information and the power failure occurrence information to the smart center 40, the electronic control unit 31 proceeds to Step H13.

In Step H13, the electronic control unit 31 determines, based on the power reception state output from the wattmeter 34, whether the house 30 has currently recovered from the power failure that has occurred in the house 30. In other words, when the state has transitioned through the state in which the commercial electric power is not available in the house 30 and has reached the state in which the commercial electric power is currently available again in the house 30, which means that the house 30 has recovered from the power failure that has occurred in the house 30, the electronic control unit 31 makes a determination “Yes” based on the power reception state acquired from the wattmeter 34, and proceeds to Step H14. On the other hand, when the commercial electric power is not available in the house 30, which means that the house 30 has not recovered yet from the power failure that has occurred in the house 30, the electronic control unit 31 makes a determination “No” based on the electric power reception state acquired from the wattmeter 34, and proceeds to Step H15. Then, the electronic control unit 31 once finishes the execution of the power failure occurrence detection program.

In Step H14, the electronic control unit 31 transmits the power failure recovery information representing that the house 30 has currently recovered from the power failure that has occurred in the house 30 along with the house identification information to the smart center 40 by following the determination result in Step H13. Specifically, the electronic control unit 31 acquires the house identification information stored in advance in the storage unit 33 at the predetermined storage location, and supplies the communication unit 32 with the house identification information and the power failure recovery information along with a transmission request as in the transmission processing of Step H12. As a result, the communication unit 32 transmits the house identification information and the power failure recovery information via the network 50 to the smart center 40 by following the supplied transmission request. Then, when the communication unit 32 transmits the house identification information and the power failure recovery information to the smart center 40, the electronic control unit 31 proceeds to Step H15, and once finishes the execution of the power failure detection program.

A description is now given of the notification transmission program to be executed by the server 41 of the smart center 40. The server 41 of the smart center 40 repeatedly starts the execution of the notification transmission program at a predetermined cycle in Step S10. As a result, when the electronic control unit 31 of the house 30 executes the power failure occurrence detection program to transmit the house identification information and the power failure occurrence information or the house identification information and the power failure recovery information via the network 50 to the smart center 40 as described above, in Step S11 of the notification transmission program, the server 41 receives and acquires the transmitted various pieces of information. Then, the server 41 accumulates and stores the house identification information and the power failure occurrence information or the received house identification information and power failure recovery information acquired as the electric power state in the power failure occurrence information storage part 47 at a predetermined storage location along with time information representing a reception time, for example, and proceeds to Step S12.

In Step S12, the server 41 provides the house identification information management part 43 with the house identification information acquired in Step S11, thereby controlling the house identification information management part 43 to identify the vehicle 10 used by the resident of the house 30 (user). The house identification information management part 43 cooperates with the vehicle information management part 45 to search the vehicle identification information storage part 46, and acquires the vehicle identification information associated with the house identification information, thereby identifying the vehicle 10 used by the user, namely the resident of the house 30. Then, the server 41 uses the vehicle identification information on the identified vehicle 10 to check a vehicle state of the vehicle 10.

Specifically, the server 41 acquires the account information associated with the vehicle ID information constructing the vehicle identification information on the identified vehicle 10, and requests the electronic control unit 11 of the vehicle 10 identified by using the account information to provide, as the vehicle state, the vehicle state information representing, for example, the current location of the vehicle 10 and the like in addition to an operation state (on state or off state) of an ignition switch (starter switch). In response to this request, when the electronic control unit 11 is ready to respond (in other words, in an activated state), the electronic control unit 11 transmits corresponding vehicle state information to the server 41. On the other hand, when the electronic control unit 11 is not ready to respond (in other words, in an inactive state in which electric power is not supplied), the electronic control unit 11 does not transmit the vehicle state information to the server 41.

As a result, when the server 41 can acquire the vehicle state information from the electronic control unit 11 of the vehicle 10, the server 41 checks whether the ignition switch (start switch) is in the on state or the off state based on the vehicle state information. On the other hand, when the server 41 cannot acquire the vehicle state information from the electronic control unit 11 of the vehicle 10, for example, before a predetermined period elapses, the server 41 determines that the ignition switch (start switch) is in the off state. Then, after the server 41 checks the vehicle state of the identified vehicle 10, the server 41 proceeds to Step S13.

In Step S13, the server 41 determines whether the ignition switch (start switch) of the vehicle 10 identified in Step S12 is in the on state or not. In other words, when the ignition switch (start switch) of the identified vehicle 10 is in the on state, at least the user (driver) can drive the vehicle 10, and the server 41 thus makes a determination “Yes”, and proceeds to Step S14.

In Step S14, the server 41 transmits the power failure occurrence notification notifying a power failure currently occurring at the house 30 (own house) or the power failure recovery notification notifying recovery from a power failure, which has occurred at the house 30 (own house), to the user (resident) of the vehicle 10 identified in Step S12. In other words, when the power failure occurrence information is received along with the house identification information in Step S11, the server 41 uses the communication control part 42 to transmit the power failure occurrence notification to the identified vehicle 10, thereby notifying the user (resident) of the occurrence of the power failure at the house 30 of the user (resident).

On the other hand, when the power failure recovery information is received along with the house identification information in Step S11, the server 41 uses the communication control part 42 to transmit the power failure recovery notification to the identified vehicle 10, more specifically, to the vehicle 10 to which the power failure occurrence notification has been transmitted before, thereby notifying the user (resident) of the recovery from the power failure, which has occurred at the house 30 of the user (resident). Then, after the transmission of the power failure occurrence notification or the power failure recovery notification in this way, the server 41 proceeds to Step S17, and once finishes the execution of the notification transmission program.

Moreover, in Step S13, when the ignition switch (start switch) of the vehicle 10 identified in Step S12 is not in the on state, in other words, when the ignition switch (start switch) is in the off state, the server 41 makes a determination “No”, and proceeds to Step S15. In other words, in this case, the electronic control unit 11 and the like provided on the vehicle 10 are not activated, and even when the power failure occurrence notification or the power failure recovery notification is transmitted in Step S14, the vehicle 10 highly possibly cannot receive (acquire) the notification. Therefore, the server 41 repeats the determination “No”, in Step S13 until the ignition switch (start switch) of the identified vehicle 10 is brought into the on state, and repeats the processing of Steps S11, S12, and S15.

In Step S15, the server 41 determines whether or not the power failure recovery information is received in Step S11, and the house 30 recovers from the power failure state thereof. In other words, when the house 30 has recovered from the power failure state thereof until the ignition switch (start switch) of the vehicle 10 identified in Step S12 is brought into the on state, the server 41 makes a determination “Yes”, and proceeds to Step S16. On the other hand, when the house 30 has not recovered yet from the power failure state thereof, the server 41 makes a determination “No”, returns to Step S11, and again carries out the respective pieces of step processing starting from Step S11.

In Step S16, the server 41 transmits a notification mail for notifying the occurrence of the power failure at the own house (house 30) to the user (resident) of the identified vehicle 10. In other words, in this case, until the ignition switch (start switch) of the vehicle 10 identified in Step S12 is brought into the on state, in other words, before the identified vehicle 10 is brought into a state ready for travel, the house 30 has already recovered from the power failure state, which has occurred in the house 30. Therefore, the identified vehicle 10 does not need to change the usage form of electric power consumed by the travel by the execution of the travel control assistance program described later by the electronic control unit 11. Therefore, the server 41 uses a mail address of the user (resident) included in the vehicle identification information identified in Step S12 to transmit the notification mail to the user of the vehicle 10, namely, the resident of the house 30. Then, after the server 41 transmits the notification mail via the communication control part 42, the server 41 proceeds to Step S17, and once finishes the execution of the notification transmission program.

A description is now given of the travel control assistance program executed by the electronic control unit 11 of the vehicle 10. The electronic control unit 11 of the vehicle 10 repeats start of the execution of the travel assistance program in Step C10 at a predetermined cycle when the ignition switch (start switch) is in the on state. As a result, as described above, when the server 41 of the smart center 40 executes the notification transmission program, and transmits the power failure occurrence notification and the power failure recovery notification in this order via the network 50 and the relay station 60 to the vehicle 10, in Step C11, the electronic control unit 11 receives and acquires the transmitted power failure occurrence notification and power failure recovery notification in this order as the electric power state. Then, when the electronic control unit 11 acquires at least the power failure occurrence notification, the electronic control unit 11 stores the acquired power failure occurrence notification, for example, at a predetermined storage location in the storage unit 13, and proceeds to Step C12.

In Step C12, the electronic control unit 11 determines whether the vehicle 10, which is an HV or a PHV, is currently traveling in the EV mode of traveling only by the driving forces of the motors/generators 22 and 23 by using the electric power stored in the electricity storage device 28 or not, or the vehicle 10, which is an EV, is traveling in the EV mode (normal mode) of traveling by the driving forces of the motors/generators 22 and 23 by using the electric power stored in the electricity storage device 28 without saving the stored electric power or not. In other words, when the vehicle 10 is currently traveling in the EV mode (normal mode), the electronic control unit 11 makes a determination “Yes”, and proceeds to Step C13. On the other hand, when the vehicle is traveling in the HV mode or a power saving mode as described later, not in the EV mode, the electronic control unit 11 makes a determination “No”, and proceeds to Step C14.

In Step C13, the electronic control unit 11 automatically changes the usage form of electric power on the vehicle 10, or prompts the user to change the usage form of electric power in order to supply the house 30 with the emergency electric power when the vehicle 10 arrives at the house 30 (own house) of the user currently in the power failure state, more specifically, in order to appropriately secure the electricity stored in the electricity storage device 28. A specific description is now given of this point.

First, when the vehicle 10 is an HV or a PHV, and is currently traveling in the EV mode, the electronic control unit 11 changes from a first usage form which increases the consumed electric power amount to a second usage form which can reduce the consumed electric power amount as the usage form of electric power stored in the electricity storage device 28. Specifically, the electronic control unit 11 can automatically change (switch) from the travel control in the EV mode (first usage form of electric power) to the travel control in the HV mode (second usage form of electric power) of using also the driving force of the internal combustion engine 21. In this case, when the electronic control unit 11 automatically changes (switches) from the EV mode to the HV mode, the electronic control unit 11 displays such a message as “Power failure is detected at home. To save emergency electric power, mode is switched to HV mode.” or the like on the display, or uses the speaker to acoustically output the message via the informing unit 15. In this way, the automatic change (switching) from the EV mode to the HV mode can restrain the electric power stored in the electricity storage device 28 from being consumed, and can sufficiently and quickly secure the emergency electric power at the time of arrival at the own house (house 30).

Alternatively, the electronic control unit 11 can prompt the user (driver) to change (switch) the EV mode to the HV mode. In this case, the electronic control unit 11 displays such a message as “Power failure is detected at home. To save emergency electric power, switch EV mode to HV mode and drive.” or the like on the display, or uses the speaker to inform the message as a sound output via the informing unit 15. When the user (driver) is prompted by this informing to change (switch) the EV mode to the HV mode, the electric power stored in the electricity storage device 28 can be restrained from being consumed, and the emergency electric power can be sufficiently and quickly secured at the time of arrival at the own house (house 30).

Moreover, when the vehicle is an EV, and is currently traveling in the EV mode (normal mode), the electronic control unit 11 can automatically change (switch) from the travel in the EV mode high in the consumed electric power amount to the travel in the power saving mode low in the consumed electric power amount, or high in the collected electric power amount by the regenerative electric power. In this case, in order to restrain the consumed electric power amount, the electronic control unit 11 cooperates with the navigation unit 16 to search for, for example, a route from the current location to the own house (house 30) as the destination appropriate in the power consumption rate (so-called electricity efficiency) (prioritizing electricity efficiency), specifically, a route having a smaller number of traffic signals except for portions on the highway, a route having a smaller number of ascents, or the like, and presents the retrieved route to the user (driver) to guide the route. In this case, in order to increase the collected electric power amount by the regenerative electric power, the electronic control unit 11 cooperates with the navigation unit 16 to preferentially search for, for example, a route from the current location to the own house (house 30) as the destination having descents, and presents the retrieved route to the user (driver) to guide the route. Alternatively, in order to increase the collected electric power amount by the regenerative electric power, the electronic control unit 11 restricts the driving forces generated by the motors/generators 22 and 23, and increases a regenerative control frequency of the motor generators 22 and 23 as compared with those in the EV mode (normal mode).

On this occasion, when the electronic control unit 11 automatically changes (switches) from the EV mode (normal mode) to the power saving mode, the electronic control unit 11 displays such a message as “Power failure is detected at home. To save emergency electric power, drive to home following guided route.” or the like on the display, or uses the speaker to acoustically output the message via the informing unit 15. Then, when the user (driver) is prompted by this informing to travel by following the guided route in the power saving mode, the electric power stored in the electricity storage device 28 can be restrained from being consumed and the regenerative electric power can be collected to be stored in the electricity storage device 28, and the emergency electric power can be sufficiently and quickly secured at the time of the arrival at the own house (house 30). It should be understood that the power saving mode can be applied to a state in which when the vehicle 10 is, for example, an HV or a PHV, the vehicle 10 is traveling in the EV mode.

Then, after the electronic control unit 11 automatically changes from the EV mode to the HV mode or from the EV mode to the power saving mode, or prompts the user (driver) to carry out the change as described above, the electronic control unit 11 proceeds to Step C14.

In Step C14, the electronic control unit 11 determines whether or not the power failure recovery notification is acquired after the power failure occurrence notification is acquired. In other words, when the electronic control unit 11 has acquired the power failure recovery notification by the step processing of acquiring the notification in Step C11, the electronic control unit 11 makes a determination “Yes”, and proceeds to Step C15. On the other hand, when the electronic control unit 11 has not acquired the power failure recovery notification yet by the step processing of acquiring the notification in Step C11, the electronic control unit 11 makes a determination “No”, proceeds to Step C16, and once finishes the execution of the travel control assistance program.

In Step C15, the electronic control unit 11 informs the recovery from the power failure state, which has occurred at the own house (house 30), to the user (driver) based on the determination of Step C14. Specifically, the electronic control unit 11 displays such a message as “Home has recovered from power failure.” or the like on the display, or uses the speaker to acoustically output the message via the informing unit 15. As a result, the user (driver) can, for example, change (return) from the HV mode to the EV mode to control the vehicle 10 to travel, or can change (return) from the power saving mode to the EV mode (normal mode) to control the vehicle 10 to travel. Then, after the electronic control unit 11 informs the recovery from the power failure state to the user (driver) in this way, the electronic control unit 11 proceeds to Step C16, and once finishes the execution of the travel control assistance program.

As can be understood from the description, according to the embodiment, the electronic control unit 11 installed on the vehicle 10 can acquire the power failure occurrence notification or the power failure recovery notification via the external communication unit 12 from the smart center 40 as the electric power state of the house 30 (own house), which is the external electric power supply destination. Then, when the electronic control unit 11 acquires the power failure occurrence notification, the electronic control unit 11 can change the travel control of the vehicle 10 from the travel control in the EV mode to the travel control in the HV mode, thereby changing from the large consumed electric power amount of the electric power stored in the electricity storage device 28 (first usage form of electric power) to the small consumed electric power amount of the electric power stored in the electricity storage device 28 (second usage form of electric power). Alternatively, in this case, the electronic control unit 11 can prompt the user to change the travel control of the vehicle from the travel control in the EV mode to the travel control in the HV mode via the informing unit 15, thereby changing the usage form of electric power from the first usage form to the second usage form, or prompting the change.

As a result, even when the vehicle 10 travels to the house 30 (own house), the motors/generators 22 and 23 can efficiently restrain the consumed amount of the electric power stored in the electricity storage device 28 as a result of the travel. Thus, when the vehicle 10 arrives at the house 30, the electric power stored in the electricity storage device 28, namely, the emergency electric power can be surely secured to be quickly transmitted to the house 30.

In the embodiment, when the electronic control unit 31 of the house 30 detects an occurrence of a power failure, the server 41 of the smart center 40 transmits the power failure occurrence notification to the vehicle 10, and the electronic control unit 11 of the vehicle 10 automatically changes (switches) the usage form of electric power of the vehicle 10 to the HV mode or the power saving mode for reducing the consumed electric power amount, or prompts the user (driver) to change the usage form. As a result, when the vehicle 10 arrives at the house 30 (own house), the electric power stored in the electricity storage device 28 can be surely secured, and the emergency electric power can be supplied (transmitted) from the vehicle 10 to the house 30 (own house) in the power failure state.

By the way, when a state in which the consumed amount of electric power is tight with respect to the supplied amount of electric power may occur, the consumption of the electric power needs to be restrained to save the electricity in order to cope with this state across the society. In this case, the smart center 40 requests the houses 30 in the management area to save the electricity, and, for example, in order to cut a peak of the commercial electric power consumed by the houses 30 in the management area, can prompt an active use of the electric power (emergency electric power) stored in the electricity storage devices 28 of the vehicles 10 in a time period (hereinafter referred to as peak time period) when the peak occurs. A specific description is now given of a first modified example, and the same components as those of the embodiment are denoted by the same reference numerals and are not further described.

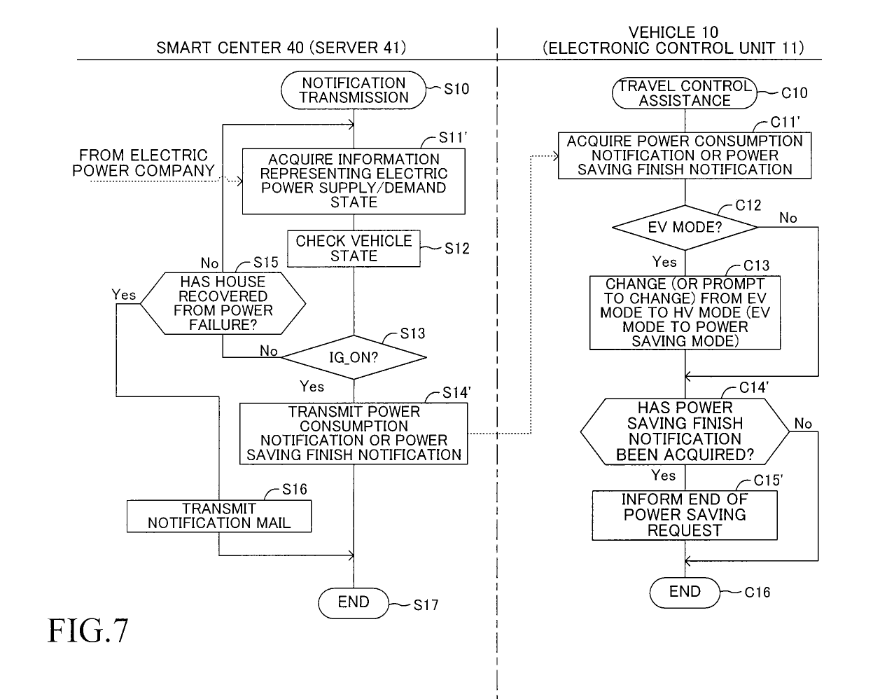

In the first modified example, the smart center 40 acquires, for example, information representing an electric power supply/demand state provided by an electric power company, and, when there is a fear that a state in which the electric power consumed amount is tight with respect to the electric power supplied amount may occur, requests the houses 30 in the management area to save the electric power. Therefore, in the first modified example, as illustrated in FIG. 7, the transmission of “power failure occurrence information” and “power failure recovery information” from the house 30 to the smart center 40 is omitted.

Moreover, as illustrated in FIG. 7, in the first modified example, the server 41 of the smart center 40 executes the notification transmission program as in the embodiment, and the electronic control unit 11 of the vehicle 10 executes the travel control assistance program as in the embodiment. However, as illustrated in FIG. 7, in the first modified example, Steps S11 and S14 in the notification transmission program are respectively changed to Steps S11′ and S14′ as compared with the embodiment. Moreover, as illustrated in FIG. 7, in the first modified example, Steps C11, C14, and C15 in the travel control assistance program are respectively changed to Steps C11′, C14′, and C15′ as compared with the embodiment.

As illustrated in FIG. 7, specifically, the notification transmission program according to the first modified example is changed so that in Step S11′, the server 41 of the smart center 40 acquires “information representing electric power supply/demand state” from the electric power company. Moreover, in the first modified example, as illustrated in FIG. 7, in Step S14′, the server 41 of the smart center 40 transmits a “power consumption notification” at a current time point in the management area based on the “information representing electric power supply/demand state” acquired in Step S11′ to the vehicle 10 when the peak time period starts. Moreover, as illustrated in FIG. 7, in Step S14′, the server 41 of the smart center 40 transmits a “power saving finish notification” based on the “information representing electric power supply/demand state” acquired in Step S11′ to the vehicle 10 when the peak time period ends.

As a result, the travel control assistance program according to the first modified example is changed so that in Step C11′, the electronic control unit 11 of the vehicle 10 acquires the “power consumption notification” or the “power saving finish notification” transmitted from the server 41 of the smart center 40. Then, when the electronic control unit 11 acquires the “power consumption notification”, the electric power is highly possibly tight, and hence in Step C13, the electronic control unit 11 automatically changes (switches) from the EV mode to the HV mode or the power saving mode, or prompts the user (driver) to carry out the change (switching). Moreover, the electronic control unit 11 determines whether the “power saving finish notification” is acquired in Step C14′ or not, and when the “power saving finish notification” is acquired, in Step C15′, the electronic control unit 11 can inform the finish of the request for the power saving to the users (drivers).

Thus, according to the first modified example, the electric power stored in the electricity storage devices 28 of the vehicles 10 can be actively used in a state in which the power saving request is made, in other words, the electric power is tight. As a result, the state in which the electric power is tight can be avoided, and the emergency electric power of the vehicle 10 can be used at the house 30 to operate home electric appliances while the commercial electric power is efficiently restrained from being used. Regarding other effects, the same effects as those of the embodiment are provided.

In the first modified example, the server 41 of the smart center 40 transmits the “power consumption notification” at the current time to the vehicle 10 when the peak time period starts. In this case, the electronic control unit 11 of the vehicle 10 may estimate the state in which the electric power is tight, for example, at a time point (time) when the vehicle 10 arrives at the house 30 (own house) as the destination from the current location, based on the “power consumption notification” at the current time point, and may execute the travel control assistance program based on the “power consumption estimation notification” representing the estimated state in which the electric power is tight.

In this case, the “power consumption estimation notification” may be generated by the smart center 40 to be transmitted to the vehicle 10, or may be generated by the vehicle 10 based on the “power consumption notification” transmitted from the smart center 40. Specifically, when the smart center 40 generates the “power consumption estimation notification”, the server 41 can estimate a future power consumption based on information representing a past power consumption state out of information representing the power consumption state provided by the electric power company, thereby generating the “power consumption estimation notification”. Moreover, when the vehicle 10 generates the “power consumption estimation notification”, and the electronic control unit 11 acquires the “power consumption notification” transmitted from the smart center 40 at a certain time point, the electronic control unit 11 estimates the power consumption at a time (in a time period) of arrival at the house 30 (own house) as the destination, thereby generating the “power consumption estimation notification”.

Thus, in this case, the electronic control unit 11 can estimate the power consumption at the time (in the time period) of arrival of the vehicle 10 at the house 30 (own house) as the destination to execute the travel control assistance program. As a result, the electric power (emergency electric power) stored in the electricity storage device 28 of the vehicle 10 can be more appropriately secured.

Moreover, in the embodiment, when the electronic control unit 31 of the house 30 detects an occurrence of a power failure, the server 41 of the smart center 40 transmits the power failure occurrence notification to the vehicle 10. As a result, the smart center 40 can recognize a state of occurrences of the power failure at all the houses 30 in the management area to transmit the “power failure occurrence notification” and the “power failure recovery notification” to the vehicle 10. In this case, the vehicle 10 may acquire the “power failure occurrence notification” and the “power failure recovery notification” directly from the house 30, which is the own house, without an intervention of the smart center 40. A specific description is now given of a second modified example, and the same components as those of the embodiment are denoted by the same reference numerals and are not further described.

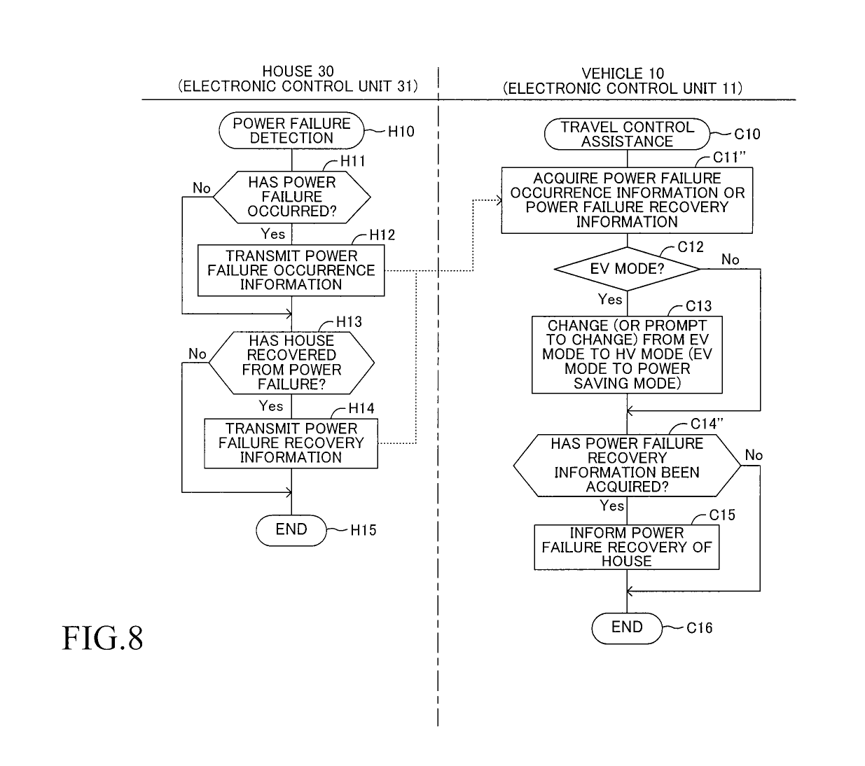

In the second modified example, as illustrated in FIG. 8, the smart center 40 is omitted. As a result, the transmission of the “power failure occurrence information” and the “power failure recovery information” from the house 30 to the smart center 40, and the transmission of the “power failure occurrence notification” and the “power failure recovery notification” from the smart center 40 to the vehicle 10 which are described above in the embodiment are omitted.

Then, in the second modified example, as illustrated in FIG. 8, the electronic control unit 31 of the house 30 executes the power failure occurrence detection program as in the embodiment. However, in the second modified example, in Steps H12 and H14 of the power failure occurrence detection program, the electronic control unit 31 transmits the “power failure occurrence information” and the “power failure recovery information” to the vehicle 10.

Moreover, in the second modified example, as illustrated in FIG. 8, the electronic control unit 11 of the house 10 executes the travel assistance program as in the embodiment. However, in the second modified example, in Step C11″ of the travel assistance program, the electronic control unit 11 acquires the “power failure occurrence information” or the “power failure recovery information” from the house 30 (own house). Then, when the electronic control unit 11 acquires the “power failure occurrence information”, in order to supply the house 30, which is the own house, with appropriate emergency electric power, in Step C13, the electronic control unit 11 automatically changes (switches) from the EV mode to the HV mode or the power saving mode, or prompts the user (driver) to carry out the change (switching). Moreover, in the second modified example, the electronic control unit 11 determines whether the “power failure recovery information” is acquired in Step C14″ of the travel assistance program or not, and when the “power failure recovery information” is acquired, in Step C15″, the electronic control unit 11 can inform the user (driver) of the recovery from the power failure state.

Thus, in the second modified example, the “power failure occurrence information” and the “power failure recovery information” can be directly acquired from the house 30, which is the own house, and the electric power stored in the electricity storage device 28 of the vehicle 10 can be used. Regarding other effects, the same effects as those of the embodiment are provided.

In the second modified example, the electronic control unit 31 of the house 30 directly transmits the “power failure occurrence information” and the “power failure recovery information” to the vehicle 10. In this case, for example, if it is estimated in advance that consumed electric power when the home electric appliances are used by family members at the house 30 increases, “consumed electric power increase information” and “home electric appliance usage finish information” may be transmitted to the vehicle 10 in place of the “power failure occurrence information” and the “power failure recovery information”. In this case, the “consumed electric power increase information” and the “home electric appliance usage finish information” can be quickly transmitted directly from the house 30, which is the own house, to the vehicle 10, and the electric power stored in the electricity storage device 28 of the vehicle 10 can be efficiently used. Regarding other effects, the same effects as those of the embodiment are provided.

Further, in this case, the “consumed electric power increase information” and the “home electric appliance usage finish information” may be transmitted along with the house identification information to the smart center 40. In this case, the server 41 of the smart center 40 can identify the vehicle 10 associated with the house identification information to notify the vehicle 10 of the “consumed electric power increase information” and the “home electric appliance usage finish information”. Thus, the electric power stored in the electricity storage device 28 of the vehicle 10 can be efficiently used also in this case.

In carrying out the present invention, the present invention is not limited to the above-mentioned embodiment and respective modified examples, and different kinds of changes can be made thereto without departing from an object of the present invention.

For example, in the embodiment, the server 41 of the smart center 40 determines that the power failure state has occurred in the house 30 based on the “power failure occurrence information” transmitted by the electronic control unit 31 of the house 30, and determines that the house 30 recovers from the power failure state, which has occurred in the house 30, based on the “power failure recovery information”. This configuration is extremely efficient, for example, for a state in which a failure occurs in a power transmission line for supplying each of the houses 30 with the commercial electric power or the like, and a power failure occurs in each of the houses 30, or each of the houses 30 recovers from the power failure.

In contrast, for example, a state in which a power failure occurs in an entire area of the management area due to circumstances of the electric power company (power plant) for supplying the houses 30 in the management area with the commercial electric power is conceivable. In such state, regardless of presence/absence of the “power failure occurrence information” or the “power failure recovery information” transmitted from the houses 30, for example, the server 41 of the smart center 40 may transmit the “power failure occurrence information” or the “power failure recovery information” to the vehicles 10 having the vehicle identification information associated with the house identification information on the houses 30 in the management area, based on information on the supply of the electric power provided by the electric power company (power plant). The same effects as those of the embodiment can be provided also in this case.

Further, in the above-mentioned embodiment and respective modified examples, the vehicle 10 includes the external communication unit 12 as communication means. In this case, an external communication function of a portable information terminal (such as a cellular phone including a smartphone, a tablet terminal, and a note PC) held by the user (driver) of the vehicle 10 may be used in addition to or in place of the external communication unit 12 provided for the vehicle 10. In this case, the vehicle 10 and the portable information terminal are configured to be able to carry out mutual short-distance communication (to be able to carry out communication through, for example, Bluetooth (trademark) or Wi-Fi (trademark)), and the electronic control unit 11 communicates via the portable information terminal to/from the smart center 40 (or the house 30). With this configuration, the same effects as those of the above-mentioned embodiment and respective modified examples can be expected.

1. A vehicle travel control assistance device, which is applicable to a vehicle that comprises:
a motor/generator for generating a driving force and generating regenerative electric power; and
an electricity storage device, which is electrically connected to the motor/generator, for supplying electric power to the motor/generator and storing the regenerative electric power therein, and supplying the stored regenerative electric power to an outside,
the vehicle being capable of providing a plurality of pieces of travel control using at least the driving force generated by the motor/generator,
the vehicle travel control assistance device comprising control means for assisting a change in the plurality of pieces of travel control,
the control means being configured to:
acquire an electric power state relating to supply and demand of electric power at an external electric power supply destination to which the electric power stored in the electricity storage device is to be supplied; and
change a usage form of electric power in which at least the motor/generator consumes the electric power stored in the electricity storage device as the vehicle travels depending on the acquired electric power state, or inform to prompt to change the usage form of electric power.

2. A vehicle travel control assistance device according to claim 1, wherein the control means is configured to acquire, as the electric power state, at least an occurrence state of a power failure in which commercial electric power is not supplied to the external electric power supply destination, or a state in which a consumed amount of electric power is tight with respect to a supplied amount of electric power at the external electric power supply destination.

3. A vehicle travel control assistance device according to claim 2, wherein the control means is configured to acquire the occurrence state of the power failure or the state in which the consumed amount of electric power is tight with respect to the supplied amount of electric power as a state of an area in which the external electric power supply destination exists.

4. A vehicle travel control assistance device according to claim 2, wherein the control means is configured to acquire a state in which the consumed amount of electric power is tight with respect to the supplied amount of electric power in future, which is estimated by using the consumed amount of electric power with respect to the supplied amount of electric power at a current time point, as the state in which the consumed amount of electric power is tight with respect to the supplied amount of electric power.

5. A vehicle travel control assistance device according to claim 4, wherein the estimated state in the future in which the consumed amount of electric power is tight with respect to the supplied amount of electric power comprises a state in which the consumed amount of electric power is tight with respect to the supplied amount of electric power at a time point when the vehicle arrives at the external electric power supply destination.

6. A vehicle travel control assistance device according to claim 1, wherein the control means is configured to change, depending on the acquired electric power state, the usage form of electric power from a first usage form of electric power in which an electric power consumed amount of the electric power stored in the electricity storage device, which is consumed as the vehicle travels, increases to a second usage form of electric power in which the electric power consumed amount of the electric power stored in the electricity storage device, which is consumed as the vehicle travels, decreases as compared with the first usage form of electric power, or inform to prompt to change the usage form of electric power from the first usage form of electric power to the second usage form of electric power.

7. A vehicle travel control assistance device according to claim 6, wherein, when the control means acquires, as the acquired electric power state, at least an occurrence state of a power failure in which commercial electric power is not supplied to the external electric power supply destination, or a state in which a consumed amount of electric power is tight with respect to a supplied amount of electric power at the external electric power supply destination, the control means is configured to change the usage form of electric power from the first usage form of electric power to the second usage form of electric power or inform to prompt to change the usage form of electric power from the first usage form of electric power to the second usage form of electric power.

8. A vehicle travel control assistance device according to claim 6,
wherein the vehicle comprises an internal combustion engine installed thereon in addition to the motor/generator, and is capable of carrying out travel control in a travel mode of using only the driving force of the motor/generator and a travel mode of using both the driving force of the motor/generator and a driving force of the internal combustion engine, and
wherein the control means is configured to change, depending on the acquired electric power state, the travel control from travel control in the travel mode of using only the driving force of the motor/generator to travel control in the travel mode of using both the driving force of the motor/generator and the driving force of the internal combustion engine, or inform to prompt to change the travel control from the travel control in the travel mode of using only the driving force of the motor/generator to the travel control in the travel mode of using both the driving force of the motor/generator and the driving force of the internal combustion engine, thereby changing the usage form of electric power from the first usage form of electric power to the second usage form of electric power.

9. A vehicle travel control assistance device according to claim 6, further comprising route search means for searching for a route to a predetermined destination,
wherein the control means is configured to, when the vehicle is under the travel control in the travel mode of using the driving force of the motor/generator:
control the route search means to search for at least one of a route of suppressing the consumption of the electric power by the motor/generator or a route of increasing a collected electric power amount of the regenerative electric power by the motor/generator among routes from a current location of the vehicle to the external electric power supply destination; and
present and guide the route retrieved by the route search means depending on the acquired electric power state, and change the first usage form of electric power to the second usage form of electric power.

10. A vehicle travel control assistance device according to claim 9, wherein the control means is configured to, when the vehicle is under the travel control in the travel mode of using the driving force of the motor/generator, depending on the acquired electric power state, increase a frequency of regenerative control for the motor/generator so as to increase the collected electric power amount of the regenerative electric power, or limit a magnitude of the driving force generated by the motor/generator.

11. A vehicle travel control assistance device according to claim 1,
wherein the external electric power supply destination comprises an own house of a user of the vehicle, and
wherein the control means is configured to acquire the electric power state via communication from an external center provided to be able to communicate to/from the own house, or via a direct communication from the own house.

12. A vehicle travel control assistance device according to claim 11,
wherein the external center is arranged to be able to communicate to/from a plurality of houses in an area including the own house; and
wherein the external center is configured to transmit the electric power states transmitted from the plurality of houses to the control means provided on vehicles relating to the respective plurality of houses.
